(19) United States
(12) Patent Application Publication
(10) Pub. No.: US 2021/0182678 A1
(43) Pub. Date: Jun. 17, 2021

(54) DATA PROCESSING SYSTEM AND DATA PROCESSING METHOD

(71) Applicant: OLYMPUS CORPORATION, Tokyo (JP)

(72) Inventor: Yoichi YAGUCHI, Tokyo (JP)

(73) Assignee: OLYMPUS CORPORATION, Tokyo (JP)

(21) Appl. No.: 17/185,810

(22) Filed: Feb. 25, 2021

Related U.S. Application Data
(63) Continuation of application No. PCT/JP2018/032483, filed on Aug. 31, 2018.

(51) Int. Cl. G06N 3/08; G06N 3/04; G06K 9/62

(52) U.S. Cl. CPC G06N 3/08; G06K 9/6202; G06N 3/0481

(57) ABSTRACT

A data processing system includes: a processor including hardware, wherein the processor performs a process determined by a neural network. An optimization parameter of the neural network is optimized based on a comparison between output data output when learning data is subject to the process and ideal output data for the learning data. The processor is configured to: output a feature map having the same width and height as the intermediate data by applying, in an M-th (M is an integer equal to or larger than 1) intermediate layer, an operation to intermediate data representing input data input to the M-th intermediate layer, the operation including a convolutional operation that uses a convolutional kernel comprised of the optimization parameter; multiply the intermediate data and the feature map mutually at each corresponding coordinate, the intermediate data being input to the M-th intermediate layer, and the feature map being output by inputting the intermediate data to the M-th intermediate layer; and execute a pooling process in an (M+1)-th intermediate layer on the intermediate data output by executing multiplication.

### CROSS-REFERENCE TO RELATED APPLICATIONS

This application is based upon and claims the benefit of priority from International Application No. PCT/JP2018/032483, filed on Aug. 31, 2018, the entire contents of which is incorporated herein by reference.

### BACKGROUND OF THE INVENTION

### 1. Field of the Invention

The present invention relates to data processing technologies and, more particularly, to a data processing technology that uses a trained deep neural network.

### 2. Description of the Related Art

A convolutional neural network (CNN) is a mathematical model including one or more non-linear units and is a machine learning model that predicts an output corresponding to an input. A majority of convolutional neural networks include one or more intermediate layers (hidden layers) other than the input layer and the output layer. The output of each intermediate layer represents an input to the next layer (the intermediate layer or the output layer). Each layer of the convolutional neural network generates an output according to the input and the parameter of the layer.

### Non-Patent Literature 1

Alex Krizhevsky, Ilya Sutskever, Geoffrey E. Hinton, “ImageNet Classification with Deep Convolutional Neural Networks”, NIPS2012_4824

A convolutional neural network generally includes a pooling process for performing reduction in a planar direction. We have made an extensive study and realized that a network is trained so that the data input to a pooling process is used more effectively by performing reduction in a planar direction by a method suited to the input, taking an advantage of end-to-end training, and that the precision of prediction for unknown data is improved as a result.

### SUMMARY OF THE INVENTION

The present invention addresses the above-described issue, and a general purpose thereof is to provide a technology capable of improving the precision of prediction for unknown data.

A data processing system according to an embodiment of the present invention includes: a processor including hardware, wherein the processor performs a process determined by a neural network including an input layer, one or more intermediate layers, and an output layer. An optimization parameter of the neural network is optimized based on a comparison between output data output by executing the process on learning data and ideal output data for the learning data, and the processor is configured to: by applying, in an M-th (M is an integer equal to or larger than 1) intermediate layer, an operation to intermediate data representing input data input to the M-th intermediate layer, output a feature map having the same width and height as the intermediate data, the operation including a convolutional operation that uses a convolutional kernel comprised of the optimization parameter; multiply the intermediate data and the feature map mutually at each corresponding coordinate, the intermediate data being input to the M-th intermediate layer, and the feature map being output by inputting the intermediate data to the M-th intermediate layer; and execute a pooling process in an (M+1)-th intermediate layer on the intermediate data output by executing the multiplication.

Another embodiment of the present invention also relates to a data processing system. The data processing system includes: a processor including hardware, wherein the processor outputs, by subjecting learning data to a process determined by a neural network, output data responsive to the learning data, the neural network including an input layer, one or more intermediate layers, and an output layer. The processor is configured to train the neural network based on a comparison between output data responsive to the learning data and ideal output data for the learning data, wherein training of the neural network is optimization of an optimization parameter of the neural network. In the training, by applying, in an M-th (M is an integer equal to or larger than 1) intermediate layer, an operation to intermediate data representing input data input to the M-th intermediate layer, the processor: outputs a feature map having the same width and height as the intermediate data, the operation including a convolutional operation that uses a convolutional kernel comprised of the optimization parameter; multiplies the intermediate data and the feature map mutually at each corresponding coordinate, the intermediate data being input to the M-th intermediate layer, and the feature map being output by inputting the intermediate data to the M-th intermediate layer; and executes a pooling process in an (M+1)-th intermediate layer on the intermediate data output by executing the multiplication.

Still another embodiment of the present invention relates to a data processing method. The method includes: outputting, by subjecting learning data to a process determined by a neural network, output data responsive to the learning data, the neural network including an input layer, one or more intermediate layers, and an output layer, wherein an optimization parameter of the neural network is optimized based on a comparison between output data output by executing the process on learning data and ideal output data for the learning data. The process determined by the neural network includes: by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter; multiplying the intermediate data and the feature map mutually at each corresponding coordinate, the intermediate data being input to the M-th intermediate layer, and the feature map being output by inputting the intermediate data to the M-th intermediate layer; and executing a pooling process in an (M+1)-th intermediate layer on the intermediate data output by executing the multiplication.

Yet another embodiment of the present invention relates to a data processing method. The method includes: outputting, by subjecting learning data to a process determined by a neural network, output data responsive to the learning data, the neural network including an input layer, one or more intermediate layers, and an output layer;

training the neural network by optimizing an optimization parameter of the neural network based on a comparison between output data responsive to the learning data and ideal output data for the learning data. Training of the neural network includes: by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter; multiplying the intermediate data and the feature map mutually at each corresponding coordinate, the intermediate data being input to the M-th intermediate layer, and the feature map being output by inputting the intermediate data to the M-th intermediate layer; and executing a pooling process in an (M+1)-th intermediate layer on the intermediate data output by executing the multiplication.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the function and the configuration of a data processing system according to an embodiment;

FIG. 2 schematically shows a part of the configuration of the neural network;

FIG. 3 is a flowchart showing the learning process performed by the data processing system; and

FIG. 4 is a flowchart showing the application process performed by the data processing system.

### DETAILED DESCRIPTION OF THE INVENTION

The invention will now be described by reference to the preferred embodiments. This does not intend to limit the scope of the present invention, but to exemplify the invention.

Hereinafter, the present invention will be described based on preferred embodiments with reference to the accompanying drawings.

A description will be given below of a case where the data processing apparatus is applied to image processing, but it would be understood by those skilled in the art that the data processing apparatus can also be applied to sound recognition process, natural language process, and other processes.

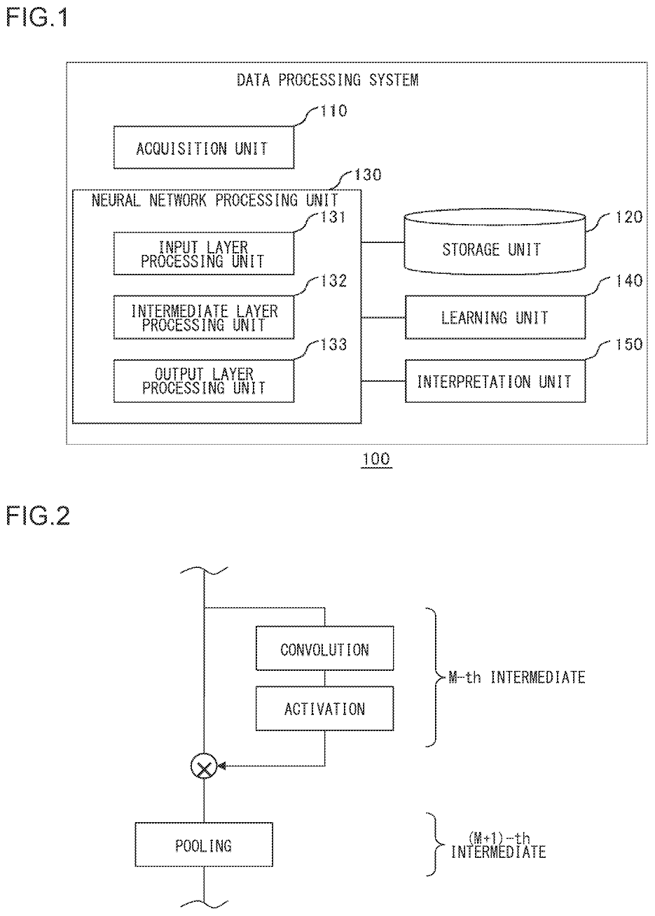

FIG. 1 is a block diagram showing the function and configuration of a data processing system 100 according to an embodiment. The blocks depicted here are implemented in hardware such as devices and mechanical apparatus exemplified by a CPU of a computer, and in software such as a computer program. FIG. 1 depicts functional blocks implemented by the cooperation of these elements. Therefore, it will be understood by those skilled in the art that the functional blocks may be implemented in a variety of manners by a combination of hardware and software.

The data processing system 100 performs a “learning process” of training a neural network based on an image for learning (learning data) and a ground truth value, which represents ideal output data for the image. The data processing system 100 also performs an “application process” of applying a trained neural network to an unknown image (unknown data) and performing image processes such as image categorization, object detection, or image segmentation.

In the learning process, the data processing system 100 subjects an image for learning to a process in accordance with the neural network and outputs output data responsive to the image for learning. The data processing system 100 updates the parameter (hereinafter, “optimization parameter”) of the neural network which is subject to optimization (training) in a direction in which the output data approaches the ground truth value. The optimization parameter is optimized by repeating the above steps.

In the application process, the data processing system 100 uses the optimization parameter optimized in the learning process to subject an unknown image to a process in accordance with the neural network and outputs output data responsive to the image. The data processing system 100 interprets the output data to categorize the image, detect an object in the image, or subject the image to image segmentation.

The data processing system 100 includes an acquisition unit 110, a storage unit 120, a neural network processing unit 130, a learning unit 140, and an interpretation unit 150. The function of the learning process is mainly implemented by the neural network processing unit 130 and the learning unit 140, and the function of the application process is mainly implemented by the neural network processing unit 130 and the interpretation unit 150.

In the learning process, the acquisition unit 110 acquires a plurality of images for learning and ground truth values corresponding to the plurality of images for learning, respectively, at a time. In the application process, the acquisition unit 110 acquires an unknown image subject to the process. The embodiment is non-limiting as to the number of channels of the image. For example, the image may be an RGB image or a gray scale image.

The storage unit 120 stores the image acquired by the acquisition unit 110. The storage unit 120 also serves as a work area of the neural network processing unit 130, the learning unit 140, and the interpretation unit 150 or as a storage area for the parameter of the neural network.

The neural network processing unit 130 performs a process in accordance with the neural network. The neural network processing unit 130 includes an input layer processing unit 131 for performing a process corresponding to the input layer of the neural network, an intermediate layer processing unit 132 for performing a process corresponding to the intermediate layer, and an output layer processing unit 133 for performing a process corresponding to the output layer.

FIG. 2 schematically shows a part of the configuration of the neural network. The intermediate layer processing unit 132 performs, as the process in the M-th (M is an integer equal to or larger than 1) intermediate layer, a feature map output process for outputting a feature map having the same width and height as the intermediate data representing input data. In the feature map output process, the aforementioned feature map is output by applying a computation, including a convolutional operation that uses a convolutional kernel comprised of an optimization parameter, to the intermediate data. In this embodiment, the intermediate layer processing unit 132 applies, as the feature map output process, a convolutional operation and an activation process to the intermediate data. The intermediate layer processing unit 132 performs a multiplication process for multiplying the intermediate data that should be input to the M-th intermediate layer and intermediate data output by inputting the intermediate data to the M-th intermediate layer.

The feature map output process and the multiplication process are collectively referred to as an excitation process. The excitation process is given by the following expression (1).

y=x⊙F_{sig}(F_{conv}(x; w)) (1)

x: input
y: output
⊙: pixel-by-pixel multiplication
F_{conv}(⋅; w): convolutional function that convolutes the kernel w
F_{sig}(⋅): sigmoid function

The vertical and horizontal sizes of a kernel w are arbitrary integers larger than 1.

Further, the intermediate layer processing unit 132 performs, as the process in the (M+1)-th intermediate layer, a pooling process on the intermediate data output by performing the multiplication process. The pooling process is given by the following expression (2).

z=F_{avgpool}(y; s) (2)

z: reduced data
F_{avgpool}(⋅; s): average pooling function of a window size s

The learning unit 140 optimizes the optimization parameter of the neural network. The learning unit 140 calculates an error by using an objective function (error function) for comparing the output obtained by inputting the image for leaning to the neural network processing unit 130 and the ground truth value corresponding to the image. The learning unit 140 calculates a gradient for the parameter by the gradient back propagation method, etc., based on the calculated error, and updates the optimization parameter of the neural network based on the momentum method.

The optimization parameter is optimized by repeating the acquisition of the image for learning by the acquisition unit 110, the process performed on the image for learning by the neural network processing unit 130 in accordance with the neural network, and the update to the optimization parameter performed by the learning unit 140.

Further, the learning unit 140 determines whether learning should be terminated. The condition for termination may include, for example, that learning has been performed a predetermined number of times, an instruction for termination is received from outside, the average value of the amounts of update of the optimization parameter has reached a predetermined value, or the calculated error falls within a predetermined range. When the condition for termination is met, the learning unit 140 terminates the learning process. When the condition for termination is not met, the learning unit 140 returns the process to the neural network processing unit 130.

The interpretation unit 150 interprets the output from the output layer processing unit 133 to perform image categorization, object detection, or image segmentation.

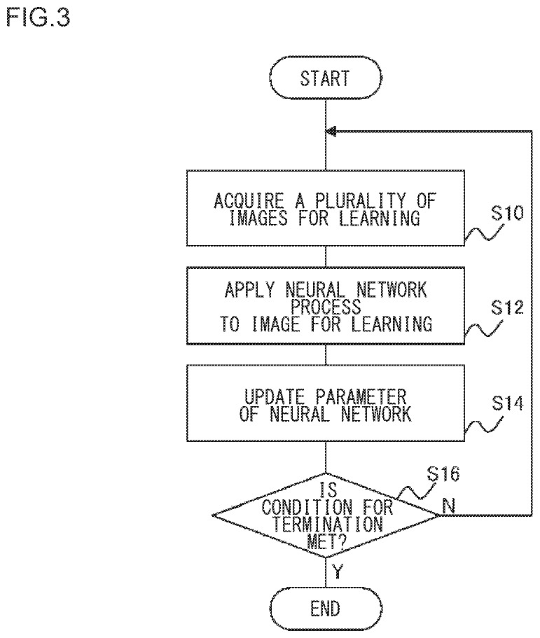

A description will be given of the operation of the data processing system 100 according to the embodiment. FIG. 3 is a flowchart showing the learning process performed by the data processing system 100. The acquisition unit 110 acquires a plurality of images for learning (S10). The neural network processing unit 130 subjects each of the plurality of images for learning acquired by the acquisition unit 110 to the process in accordance with the neural network and outputs respective output data (S12). The learning unit 140 updates the parameter based on the output data responsive to each of the plurality of images for learning and the ground truth for the respective images (S14). The learning unit 140 determines whether the condition for termination is met (S16). When the condition for termination is not met (N in S16), the process returns to S10. When the condition for termination is met (Y in S16), the process is terminated.

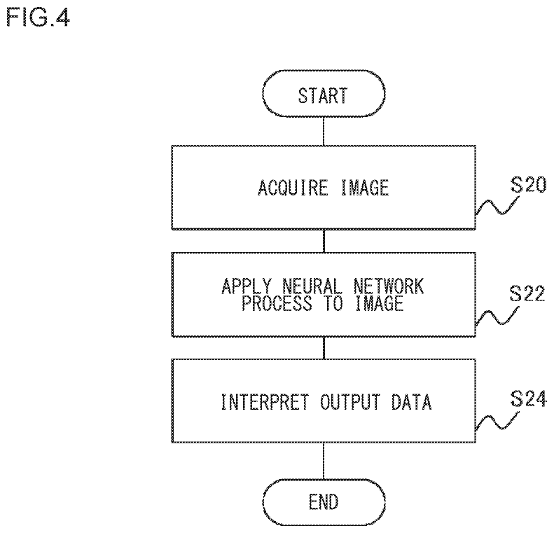

FIG. 4 is a flowchart showing the application process performed by the data processing system 100. The acquisition unit 110 acquires a plurality of target images subject to the application process (S20). The neural network processing unit 130 subjects each of the plurality of images acquired by the acquisition unit 110 to the process in accordance with the neural network in which the optimization parameter is optimized, i.e., the trained neural network, and outputs output data (S22). The interpretation unit 150 interprets the output data to categorize the target image, detect an object in the target image, or subject the target image to image segmentation (S24).

According to the data processing system 100 according to the embodiment, reduction is performed such that a feature useful for prediction of ideal output data is given a greater weight than the other features. This improves the precision of prediction of future data.

Described above is an explanation based on an exemplary embodiment. The embodiment is intended to be illustrative only and it will be understood by those skilled in the art that various modifications to combinations of constituting elements and processes are possible and that such modifications are also within the scope of the present invention.

### (Variation 1)

In the embodiment, the neural network processing unit 130 applies, in the pooling process, average pooling to intermediate data output by performing a multiplication process, but the embodiment is non-limiting as to the pooling process, and a desired method for the pooling process may be used.

For example, the neural network processing unit 130 may apply max pooling in the pooling process. More specifically, the pooling process may be given by the following expression (3).

z=Fₘₐₓₚₒₒₗ(y; s) (3)

Fₘₐₓₚₒₒₗ(⋅; s): max pooling function of a window size s

Further, the neural network processing unit 130 may apply, for example, grid pooling in the pooling process. More specifically, the pooling process may be given by the following expression (4).

z=F_{stride}(y; s) (4)

F_{stride}(⋅; s): grid pooling function of a window size s

The grid pooling function is a process to retain only those pixels that meet, for example, the following expression (5).

mod(x,s)=t (5)

t: integer not less than 0 and less than s

Further, the neural network processing unit 130 may apply, for example, sum pooling in the pooling process. More specifically, the pooling process may be given by the following expression (6). In this case, the entirety of the excited data can be utilized.

z=Fₛᵤₘₚₒₒₗ(y; s) (6)

Fₛᵤₘₚₒₒₗ(⋅; s): sum pooling function of a window size s

### (Variation 2)

Various variations of the excitation process are conceivable. For example, the excitation process may be given by the following expression (7).

y=x⊙ₑₗₑₘF_{sig}(F′_{conv}(x; w)) (7)

⊙ₑₗₑₘ: element-by-element multiplication
F′_{conv}(∩; w): function that convolutes multiple kernels w and outputs an image having the same number of channels as the input

Further, the excitation process may be given by, for example, the following expression (8).

y=x⊙exp(−(F_{conv}(x; w))² (8)

exp(⋅): exponential function with base e

In the embodiment and the variations, the data processing system may include a processor and a storage such as a memory. The functions of the respective parts of the processor may be implemented by individual hardware, or the functions of the parts may be implemented by integrated hardware. For example, the processor could include hardware, and the hardware could include at least one of a circuit for processing digital signals or a circuit for processing analog signals. For example, the processor may be configured as one or a plurality of circuit apparatuses (e.g., IC, etc.) or one or a plurality of of circuit devices (e.g., a resistor, a capacitor, etc.) packaged on a circuit substrate. The processor may be, for example, a central processing unit (CPU). However, the processor is not limited to a CPU. Various processors may be used. For example, a graphics processing unit (GPU) or a digital signal processor (DSP) may be used. The processor may be a hardware circuit comprised of an application specific integrated circuit (ASIC) or a field-programmable gate array (FPGA). Further, the processor may include an amplifier circuit or a filter circuit for processing analog signals. The memory may be a semiconductor memory such as SRAM and DRAM or may be a register. The memory may be a magnetic storage apparatus such as a hard disk drive or an optical storage apparatus such as an optical disk drive. For example, the memory stores computer readable instructions. The functions of the respective parts of the data processing system are realized as the instructions are executed by the processor. The instructions may be instructions of an instruction set forming the program or instructions designating the operation of the hardware circuit of the processor.

What is claimed is:

1. A data processing system comprising: a processor comprising hardware, wherein the processor performs a process determined by a neural network including an input layer, one or more intermediate layers, and an output layer, wherein
an optimization parameter of the neural network is optimized based on a comparison between output data output when learning data is subject to the process and ideal output data for the learning data, and
the processor is configured to:
by applying, in an M-th (M is an integer equal to or larger than 1) intermediate layer, an operation to intermediate data representing input data input to the M-th intermediate layer, output a feature map having the same width and height as the intermediate data, the operation including a convolutional operation that uses a convolutional kernel comprised of the optimization parameter;
multiply the intermediate data and the feature map mutually at each corresponding coordinate, the intermediate data being input to the M-th intermediate layer, and the feature map being output by inputting the intermediate data to the M-th intermediate layer; and
execute a pooling process in an (M+1)-th intermediate layer on the intermediate data output by executing the multiplication.

2. A data processing system comprising: a processor comprising hardware, wherein the processor outputs, by subjecting learning data to a process determined by a neural network, output data responsive to the learning data, the neural network including an input layer, one or more intermediate layers, and an output layer, wherein
the processor is configured to:
train the neural network based on a comparison between output data responsive to the learning data and ideal output data for the learning data, wherein training of the neural network is optimization of an optimization parameter of the neural network, and
training of the neural network includes:
by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter;
multiplying the intermediate data and the feature map mutually at each corresponding coordinate, the intermediate data being input to the M-th intermediate layer, and the feature map being output by inputting the intermediate data to the M-th intermediate layer; and
executing a pooling process in an (M+1)-th intermediate layer on the intermediate data output by executing the multiplication.

3. The data processing system according to claim 1, wherein
a size of the convolutional kernel in a dimension orthogonal to the dimension representing features is larger than 1.

4. The data processing system according to claim 1, wherein
the processor outputs a feature map whose size in the dimension representing features is 1.

5. The data processing system according to claim 1, wherein
the operation outputs a real value not smaller than 0 and not larger than 1 in response to an output of the convolutional operation.

6. The data processing system according to claim 1, wherein
The result of applying a sigmoid function to an output of the convolutional operation is output.

7. The data processing system according to claim 1, wherein
in the pooling process, the processor applies average pooling to intermediate data output by executing the multiplication.

8. The data processing system according to claim 1, wherein
in the pooling process, the processor applies sum pooling to intermediate data output by executing the multiplication.

9. A data processing method comprising: executing a process according to a neural network including an input layer, one or more intermediate layers, and an output layer, wherein
an optimization parameter of the neural network is optimized based on a comparison between output data output when learning data is subject to the process and ideal output data for the learning data, and
the process according to the neural network includes:
by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter;
multiplying the intermediate data and the feature map mutually at each corresponding coordinate, the intermediate data being input to the M-th intermediate layer, and the feature map being output by inputting the intermediate data to the M-th intermediate layer; and
executing a pooling process in an (M+1)-th intermediate layer on the intermediate data output by executing the multiplication.

10. A data processing method comprising:
outputting, by subjecting learning data to a process determined by a neural network, output data responsive to the learning data, the neural network including an input layer, one or more intermediate layers, and an output layer;
training the neural network by optimizing an optimization parameter of the neural network based on a comparison between output data responsive to the learning data and ideal output data for the learning data, wherein
training of the neural network includes:
by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter;
multiplying the intermediate data and the feature map mutually at each corresponding coordinate, the intermediate data being input to the M-th intermediate layer, and the feature map being output by inputting the intermediate data to the M-th intermediate layer; and
executing a pooling process in an (M+1)-th intermediate layer on the intermediate data output by executing the multiplication.

11. A non-transitory computer readable medium encoded with a program executable by a computer, the program comprising:
executing a process according to a neural network including an input layer, one or more intermediate layers, and an output layer, wherein
an optimization parameter of the neural network is optimized based on a comparison between output data output when learning data is subject to the process and ideal output data for the learning data, and
the process according to the neural network includes:
by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter;
multiplying the intermediate data and the feature map mutually at each corresponding coordinate, the intermediate data being input to the M-th intermediate layer, and the feature map being output by inputting the intermediate data to the M-th intermediate layer; and
a pooling process is executed in an (M+1)-th intermediate layer on the intermediate data output by executing the multiplication.

12. A non-transitory computer readable medium encoded with a program executable by a computer, the program comprising:
outputting, by subjecting learning data to a process determined by a neural network, output data responsive to the learning data, the neural network including an input layer, one or more intermediate layers, and an output layer; and
training the neural network by optimizing an optimization parameter of the neural network based on a comparison between output data responsive to the learning data and ideal output data for the learning data, wherein
training of the neural network includes:
by applying, in an M-th (M is an integer equal to or larger than 1) intermediate layer, an operation to intermediate data representing input data input to the M-th intermediate layer, outputting a feature map having the same width and height as the intermediate data, the operation including a convolutional operation that uses a convolutional kernel comprised of the optimization parameter;
multiplying the intermediate data and the feature map mutually at each corresponding coordinate, the intermediate data being input to the M-th intermediate layer, and the feature map being output by inputting the intermediate data to the M-th intermediate layer; and
executing a pooling process in an (M+1)-th intermediate layer on the intermediate data output by executing the multiplication.
